(19) United States
(12) Patent Application Publication
(10) Pub. No.: US 2014/0052510 A9
(43) Pub. Date: Feb. 20, 2014

(54) METHOD AND SYSTEM FOR INCENTIVIZING AN ACTIVITY OFFERED BY A THIRD PARTY WEBSITE

(71) Applicant: CHERYL MILONE, NEW YORK, NY (US)

(72) Inventor: CHERYL MILONE, NEW YORK, NY (US)

(73) Assignee: ARTICLE ONE PARTNERS HOLDINGS, NEW YORK, NY (US)

(21) Appl. No.: 12/406,119

(22) Filed: Mar. 18, 2009

Related U.S. Application Data
(60) Provisional application No. 61/069,810, filed on Mar. 18, 2008.

(51) Int. Cl. G06Q 30/00; G06Q 50/00; G06Q 10/00

(52) U.S. Cl. 705/14.11; 705/30

(57) ABSTRACT

A system for incentivizing an action offered by a third-party website. To this end, the system includes a host website comprising an offering module configured to display an incentive for taking an action on the third-party website. The host website further includes a user interface module configured to register users as participants, and accept inputs from the participants. In addition, a reporting module receives a report of an action on the third-party website and the identity of the participant taking the action. Further, an incentive calculation module present on the host website calculates an incentive applicable to the identified action and provides information regarding the calculated incentive. Moreover, a data storage module is configured to assemble, store, retrieve, and process information regarding the participant and the third-party website action.

### CROSS REFERENCE TO RELATED PATENT APPLICATIONS

This application claims the benefit of Provisional U.S. Application Ser. No. 60/069,810 filed Mar. 18, 2008, entitled “System and Method for Multi-Tier Finder's Fee Search Platforms to Provide Dynamics to Encourage Early Tier Participation,” the contents of which are incorporated herein by reference in its entirety for all purposes. This application is related to an application entitled “A method and System for Requesting Prior Art from the Public in Exchange for a Reward” (Attorney Docket No. 21233/0208018-US0) filed on Oct. 31, 2007, the contents of which are incorporated herein in their entirety for all purposes. This application is related to an application entitled “Method and System for the Requesting Receipt and Exchange of Information” (Attorney Docket No. 21233/0208249-US0) filed on Oct. 31, 2007, the contents of which are incorporated herein in their entirety for all purposes.

### TECHNICAL FIELD

The present invention relates to a method and system for incentivizing an action offered by a third-party website.

### BACKGROUND

The last decade has seen an extensive number of online public forum ventures. Online public forums typically invite members of the public to submit information pertinent to the subjects addressed by the public forum. For example, Wikipedia invites members of the public to submit explanatory articles about anything under the sun. Some other web portals allow users to post a problem, proposed solutions to which are provided by other users Still other users are allowed to rate the proposed solutions, thereby increasing overall quality.

Peer-to-Patent.com is one such public forum, created with a goal of helping to reform the patent system. Peer-to-Patent involves members of the public in conducting prior art searches for listed patent applications being examined by the USPTO. As part of its examination of a patent application, the Patent Office performs a search to locate references relevant to the claimed invention (prior art) to ensure that the invention meets statutory standards of novelty and non-obviousness. The time for each individual search is limited, which can affect the quality of the search. Peer-to-Patent aims to supplement the PTO search with contributions from persons who understand the relevant technology. Participation is at the election of the applicant, who submits a pending application for review. A statutory change provides an incentive for posting applications on Peer-to-Patent, in the form of accelerated examination of those applications.

Peer-to-Patent is a voluntary system. It relies on the voluntary submission of patent applications and voluntary submission of suggested prior art. Subsequently, the same or other members of the public engage in a follow-up review of the submitted prior art to rank it by relevance to the patent application. Finally, Peer-to-Patent provides the top 10 references to the Patent Office. Apart from the accelerated examination noted above, no incentives are provided to the applicant, prior art submitters, or prior art commentators. Peer-to-Patent operates on a website, www.peertopatent.org. This type of search, a request for information to an individual or a group of people, for example, users of a web site or employees of an organization, is referred to as a finder's search.

Another public forum, BountyQuest (now defunct) provided a finder's search process that allowed members of the public to post issued patents with a request for relevant prior art. In this case, if a public forum member submitted prior art that invalidated the issued patent, that member would win a flat monetary reward (e.g., $10,000-$50,000 or higher). Other websites operate in a similarly collaborative nature, offering flat rewards for providing solutions for scientific problems (i.e., innocentive.com) or writing computer code (i.e., topcoder.com), and so on. In contrast to the finder's search, defined above, this search represents a request for information in exchange for compensation to an individual or group of people, for example, users of a web site or employees of an organization, and is referred to as a finder's fee search.

The Peer-to-Patent process does not offer a reward to public forum members who submit prior art. While the top ten relevant prior art submissions are identified, submitters receive no compensation. Similarly, no compensation is provided for the additional process of public commentary on submitted prior art to identify the top 10 prior art references. Peer-to-Patent public forum members are encouraged to participate in order to improve the patent system and prevent overly broad and invalid patents from issuing, which can harm the community.

The Peer-to-Patent finder's search process is recognized as a premier method of uncovering prior art. While recognizing the benefits of incentive programs, it must also be recognized that offering rewards for a voluntary program with the number of patent applications exceeding 400,000 yearly can be cost prohibitive. However, the process is dependent upon the participation of patentees and public forum members. There is a need to improve the motivations for participation by patentees (of patents and patent applications) and public forum members in the government sponsored (e.g., Peer-to-Patent.com) or otherwise voluntary (e.g., a company similar to BountyQuest) finder's search process. The greater the participation, the higher the quality of the search outcome and therefore the reform of patent law to more accurately grant or maintain valid patents.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention are directed to systems for incentivizing an action offered by a third-party website. To this end, the system includes a host website comprising an offering module configured to display an incentive for taking an action on the third-party website. The host website further includes a user interface module configured to register users as participants, and accept inputs from the participants. In addition, a reporting module receives a report of an action on the third-party website and the identity of the participant taking the action. Further, an incentive calculation module present on the host website calculates an incentive applicable to the identified action and provides information regarding the calculated incentive. Moreover, a data storage module is configured to assemble, store, retrieve, and process information regarding the participant and the third-party website action.

### BRIEF DESCRIPTION OF THE DRAWINGS

FIG. 1 is an environment for implementing the embodiments of the present invention.

FIG. 2 is a block diagram of an embodiment of the invention.

FIG. 3 is a block diagram of a variation of the embodiment of FIG. 2.

FIG. 4 is a block diagram of an embodiment of the invention.

FIGS. 5(a)-5(d) illustrate alternative implementations of tiers according to the claimed invention.

### DETAILED DESCRIPTION

The following detailed description is made with reference to the figures. Preferred embodiments are described to illustrate the invention, not to limit its scope, which is defined by the claims. Those of ordinary skill in the art will recognize a variety of equivalent variations on the description that follows.

### Exemplary Environment

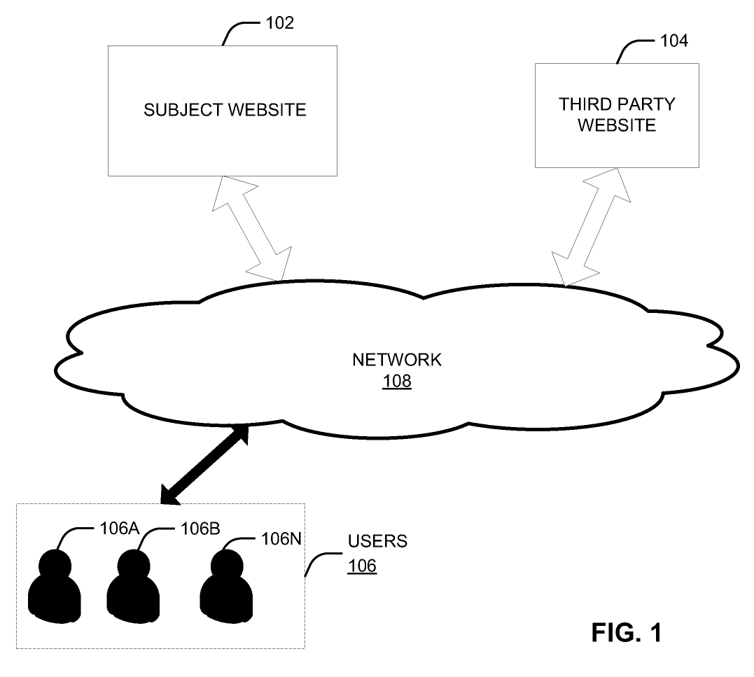

Generally, the disclosure set out below describes a system for incentivizing an action offered by a third-party website. FIG. 1 is an environment 100 for implementing the embodiments of the present invention. The environment 100 can include a host website 102, a third-party website 104 (e.g., a public forum), users 106, and a communication network 108 that permits the host website 102, the third-party website 104, and the users 106 to communicate with one another. The communication network 108 can be any network such as the Internet, Intranet, “Future Net” or any other network known or later developed which connects computing devices. Users 106 are present on computing devices 110 connected to the network 108. Computing devices 110 are shown as 110(1), 110(2) . . . 110(n), and they can be operated by the users 106(1), 106(2), 106(3), 106(4) . . . 106(N). As understood in the art, any number of computing devices 110 can be connected to the communication network 108, and each computing device 110 can be operated by any number of users 106.

The host website 102, in which embodiments of the present invention are implemented, is connected to the communication network 108. The host website 102 displays one or more incentives for completing actions on the third-party website 104. For example, the action can be a mathematical problem, a block of programming code, a prior art search for published applications or issued patents, a scientific issue, and so on. It will be understood that examples of actions stated above are mere examples and should not limit the scope of the present invention in any manner.

The host website 102 can be operatively connected to the third-party website 104 via the network 108. The third-party website 104 can take a number of forms, such as a public forum website, webpage, portal, and so on, as needed. For example, the third-party website 104 can post one or more actions to be completed by the users 106, and the users 106 can complete activities directly on the third-party website 104 or through the host website 102. In addition, the host website 102 can select some of the actions posted on the third-party website 104, and incentivize them. In one implementation, the third-party website 104 does not provide any incentives for the completion of actions, while the host website 102 does. Users 106 can register with the host website 102 and complete the actions on the third-party website 104 for an incentive. Further, the third-party website 104 or the host website 102 can provide incentives to users (action owners or other users) for submitting actions. The host website 102 can utilize a number of techniques to calculate the incentive for a particular activity. Further, the incentive can be monetary or non-monetary, based on the needs of the activity and community of users. The host website 102 will be described in detail below.

The third-party website 104 can be affiliated with or independent of the host website 102. The two websites can share management, and they can share their user base, information regarding actions, and both websites can promote one another. For example, the host website 102 can be set up by a private sector entity to contribute to the reform of the patent system and/or which seeks to develop a technology community subscriber or user base. In exchange for its contributions, the third-party website 104, such as Peer-to-Patent, can enter into a strategic relationship with the host website 102 provider, to assist in the selection of patent applications for the host website 102, reviewing and selecting the top prior art responses, as well as advertising, sharing users 106, etc. In an alternate arrangement, the third-party website 104 has no affiliation with the host website 102, and the third-party website neither promotes nor shares information related to users, actions, and so on with the host website 102. While remaining independent, the two websites can both share information encourage participation in the third-party website 104 without any formal, relationship between the entities.

In an alternative embodiment, the host website 102 can be embedded in the third-party website 104. In this situation, the host website 102 can display actions on the same public forum as the third-party website 104 (whether seamlessly within the list of actions of the third-party website 104 or in whole or in part as a separate section identifying the self-generated character of the host website 102). In another embodiment, the host website can exist as a separate entity from the third-party website 104 and can display the selected actions on a separate public forum, such as, for example, on a website separate from third-party website.

Users 106 can access the host website 102 from any computing device 110, anywhere throughout the world, having appropriate network access and software, such as a web browser. In alternative embodiments, users 106 can gain access to the host website 102 or the business supporting it, including host web-site 102 employees, from other mechanisms, such as E-mail, facsimile, or telephone.

Various hardware devices can operate host website 102. Specific devices are chosen as a matter of design choice, well known to those of ordinary skill in the art, and such choices do not limit the present invention. For example, a web server can service users 106 of the host website 102, including storing and operating the applications, displaying screen images for the host website 102 and sub-systems, and operating the host website 102, etc. In addition, a database can store activities, completed activities, users 106 associated with the completed activities, incentives, and other support data.

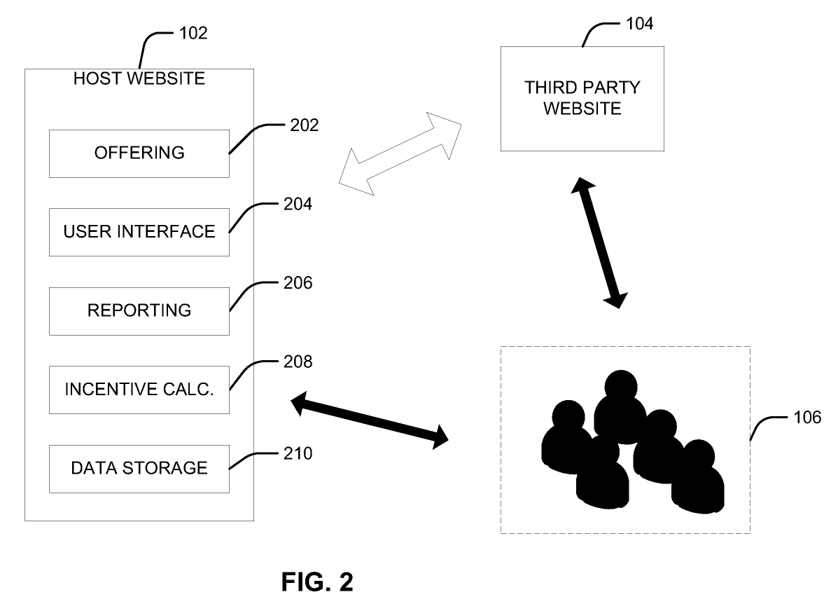

The computing devices 110 can be PDAs, PCs, laptops, mobile devices, tablets, notebooks, and so on without departing from the scope of the invention. FIG. 2 describes the host website 102 in detail.

### Exemplary Host Website

FIG. 2 is a block diagram of an embodiment of the invention. The block diagram depicts the interaction between the host website 102, the third-party website 104, and the users 106. Further, the block diagram depicts various modules of the host website 102, such as an offering module 202, a user interface module 204, a reporting module 206, an incentive calculation module 208, and a data storage module 210. Moreover, the host website 102 can include one or more processor(s). Processor(s) may include microprocessors, microcomputers, microcontrollers, digital signal processors, central processing units, state machines, logic circuitries, and/or any devices that manipulate signals based on operational instructions. Among other capabilities, processor(s) are configured to fetch and execute computer-readable instructions stored in the data storage module 210. The data storage module 210 can include any computer-readable medium known in the art including, for example, volatile memory (e.g., RAM) and/or non-volatile memory (e.g., flash, etc.).

The various modules of the host website and their interaction with the third-party website 104 and the users 106 will be described in detail in the following paragraphs. The offering module 202 is configured to display an incentive for taking an action on the third-party website 104. One or more actions that require completion can be displayed on the third-party website 104. The host website 102 can select one or more actions displayed on the third-party website 104 to incentivize, i.e., the host website 102 provides an offer of a monetary or non-monetary reward to users 106 for completing one or more actions. Depending on the action selected by the host website 102 for incentivizing, the offering module 202 displays the incentive. The incentive can be monetary, non-monetary, a lottery system and so on. Further, the offering module 202 can display the rules and conditions for receiving the incentive. For example, the method of completing the action, the details of the incentive, options for selecting different types of incentives, and so on. In one embodiment, the offering module 202 can display the action along with the incentive information. Either the action can be displayed on the host website 102 (if a user has directly posted an action on the host website) or a link for the action can be provided on the host website 102. The link can direct users to the third-party website 104 where the action is posted.

The user interface module 204 is configured to register the users 106 as participants and to accept inputs from the participants. When a user 106 visits the host website 102, the user interface module 204 can request the user 106 to register with the host webpage 102. Registering with the host webpage 102 ensures that user 106 details can be recorded and their performance can be tracked. In one implementation, the participants are allowed to complete actions incentivized by the host website 102. The participant data is stored in the data storage module 210. Whenever a participant completes an action, the details of the completed action can be stored with the corresponding participant's details. The user interface 204 can display a form on the website to be filled in by the users 106, before completing an action. In another implementation, the users 106 can be asked to register using any other means, such as via email, using a facsimile, telephone, and so on without departing from the scope of the invention.

Once the users 106 have been registered as participants, the user interface 204 can accept inputs from the participants. For example, the user interface 204 can accept inputs such as request for completing an action, receive the completed action, queries, questions, remarks, comments, suggestions, and so on. Moreover, the host website 102 can incentivize the participant added actions, and other participants are invited to try to complete these actions.

The host website 102 further includes the reporting module 206, which is configured to receive completed action details from the third-party website 104, and receive the identities of the participants that completed the action. The participants registered with the host website 102 can complete the actions incentivized by the host website 102 on the third-party website 104. In an alternate embodiment, the participants can complete the actions on the host website 102. If the participants complete the actions on the third-party website 104, the reporting module 206 can receive information regarding the actions completed by the participants, detailed reports entailing solutions provided by the participants for the actions. Further, the reporting module 206 can receive the identities of the participants who completed the actions.

In one implementation, the reporting module 106 can receive information relating only to the participants, while in another implementation it can receive information relating to the non-registered users as well. In that configuration, the user interface 204 along with the offering module 202 can inform the third-party website users about the incentives related to the completed actions, and can request the users 106 to register as participants on the host website 102 in order to avail themselves of the incentives offered by the host website 102.

An incentive calculation module 208 calculates an incentive applicable to a particular action. The host website 102 selects one or more actions from the third-party website that it wants to incentivize. Further, participants can also provide actions to the host website 102. The incentive calculation module 208 calculates the incentives based on a number of techniques. For example, the calculation module 208 can take into consideration factors such as type of action, difficulty level of the action, importance of the action, number of participants completing the action, and so on for calculating the incentives. The incentives can be monetary, or non-monetary. Examples of non-monetary incentives can be a point system, in which participants are awarded points for various actions, and they can later exchange accumulated points for merchandize, money, offers, discounts, and so on. Another incentive system could be a lottery in which cash, merchandise or other prizes are awarded, and participants receive stated numbers of “lottery tickets” for various actions. It will be understood that the incentive can have any form, and the incentives are provided to encourage more users to participate and to complete more actions on the third-party website 104.

Finally, the data storage module 210 is configured to assemble, store, retrieve, and process information regarding the participants and the third-party website action. Further, the data storage module 210 can store information regarding incentives, and other data important for the proper functioning of the host website 102. The data storage module can be a relational database, a cubic database, or other data storage system known and available to the art. Stored information regarding participants can include their particulars submitted during registration, the number of actions completed, amount of incentive received, accumulated points (if applicable), number of actions still pending, details of completed actions, reports received by the reporting module 206, and so on. The data storage module 210 can be stored in memory.

In one embodiment, the third-party website does not offer any incentives for action completion, while the host website offers an incentive for actions selected by the host party for incentivizing. In another embodiment, both the third-party website and the host website offer an incentive, but the host website offers a larger incentive than the third-party website. In certain situations, if the participants complete the activity on the third-party website, the participant can get both the incentives. In yet another embodiment, the host website and the third-party website offer almost the same incentives for completing an action. In this situation, if a participant completes the action, the participant receives an incentive from both the websites. However, users that do not register with the host website and complete the action on the third-party website only receive the incentive offered by the third-party website 104.

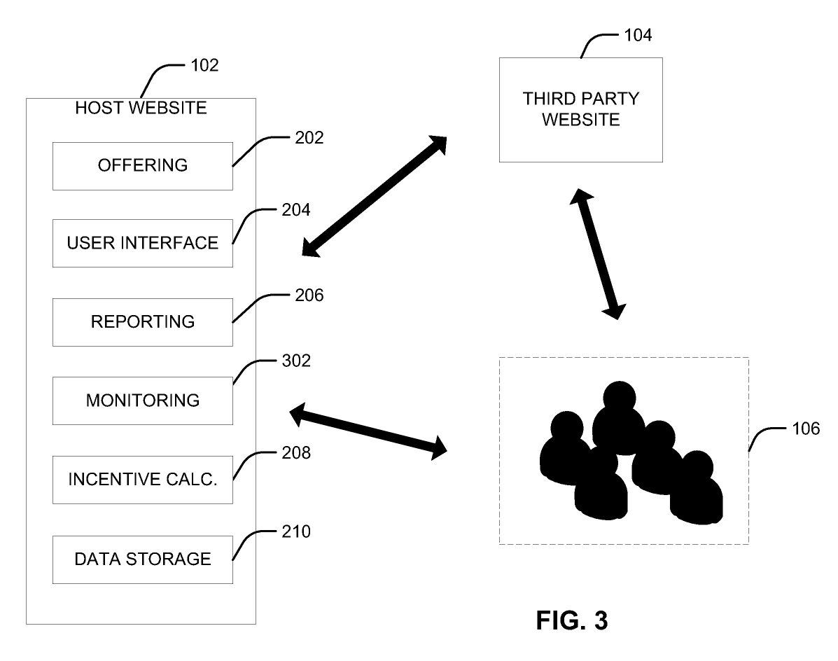

FIG. 3 is a block diagram of a variation of the embodiment of FIG. 2. The block diagram and the interactions of the elements in FIG. 3 are similar to FIG. 2 except that the figure depicts one more module of the host website 102. A monitoring module 302 is included, configured to monitor actions reported on the third-party website 104 and to identify actions taken by participants. The monitoring module 302 interacts with the third-party website 104 and constantly monitors its activities. In one implementation, the monitoring module monitors all the actions selected by the host website 104 for incentivization. It monitors the status of the action, the number of users completing the action, the results uploaded by users 106 for the actions, and so on. Out of all the users 106 that post results for actions on the third-party website 104, the monitoring module 302 identifies the participants that are registered with the host website 102. Information regarding the identified participants along with the corresponding actions can be stored in the data storage module 210.

All the other modules of the host website depicted in FIG. 3 carry out the same functions as described in relation to FIG. 2. Further, all the embodiments described in relation to FIG. 2 can also be applied to the embodiment described here.

### EXEMPLARY EMBODIMENTS

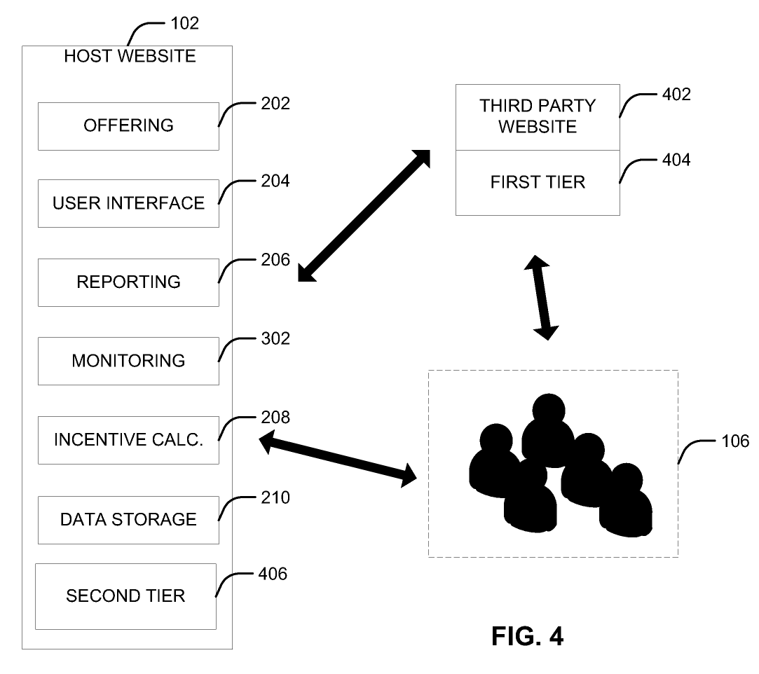

FIG. 4 illustrates an embodiment of the invention aimed specifically at incentivizing the provision of finder's searches for prior art relating to published patent applications or issued patents. Here, third-party website 102 can host finder's searches (actions) for patent applications, issued patents, or other patent related documents (activities) and the host website 102 can select one or more finder's searches for incentivizing. For example, the third-party website 104 can be the Peer-to-Patent system discussed above, which hosts patent applications but does not provide any incentives, or it could represent a system such as BountyQuest, which hosts issued patents and provides monetary incentives to users 106. Incentivized finder's searches can also be referred to as finder's fee searches. As shown, the block diagram depicts a third-party website 402, the host website 102, and users 106. The third-party website 402 hosts finder's searches for patent applications or issued patents. The finder's searches can be prior art searches for patentability of published applications or invalidity searches for issued patents. To explain the host website 102 of the present invent, the Peer-to-Patent website will be considered as an example of the third-party website 104 in the following sections. It will, however, be understood that Peer-to-Patent is only taken as an example, and any other public forum website can be employed without departing from the scope of the present invention.

The host website 102 functions in the same manner as described earlier. The offering module 202 displays incentives for providing finders search results on the third-party website 402. The user interface module 204 registers users as participants and accepts inputs from participants. The reporting module receives reports of the finder's search results and identity of the participants that provided the search results. The incentive calculation module calculates applicable incentives and provides the incentive information. The data storage module stores information regarding search results, finder's searches, participants, and incentives.

Further, the third-party website 402 includes a first tier 404. The first tier includes a listing of voluntarily submitted pending patent applications and issued patents. A submission is considered voluntary if the owner of the patent makes the submission. The owner can be the inventor, assignee, someone who has legal rights of the patent, and so on. For example, in Peer-to-Patent all patent applications requesting finder's searches are submitted by owners.

Moreover, a second tier 406 is included in the host website 102. The second tier includes a listing of patent applications and issued patents submitted by a party other than the owner. For example, participants on the host website can submit patents and published applications. Generally, such persons have some interest in limiting or eliminating the document, such as a competitor or defendant in an infringement action.

In Peer-to-Patent, a published patent application (activity) can be available prior to the statutory 18-month publication date, if the owner posts the application during that period. As noted above, submitting a patent publication on the first tier 404 offers the benefit of accelerated examination in the USPTO, or other specific benefits to owners.

In addition, voluntarily participating in the prior art searching process on the first tier can insulate the owner from potential second tier selection on the host website 102. A patent application can be selected by the host website 102 after the 18-month statutory period for publication for those patent applications that were not voluntarily submitted to the first tier 404. The host website 102 includes the second tier 406, where the host website 102 systematically selects patent applications for posting and requesting prior art, without involving any third-party in the selection of the patent applications. The host website can self-generate patent or patent application subject matter for prior art searches, which are listed in the second tier 406. The host website 102 bases the selection on its own internal process or, in alternative embodiments, can enlist in whole or in part the assistance of reviewing bodies. For example, the monitoring module 302 can monitor 18-month published applications based on any set of criteria, e.g., key patent applications in a given industry, by a given assignee or inventor, or other useful criteria, and based on the results of that process it can select one or more of the applications for posting on the host website 102.

Besides selecting patent applications from the third-party for posting, the host website 102 can differ from the third-party website 402 in other ways. For example, the host website can (i) offer greater rewards to participants for submitting the closest prior art and/or (ii) eliminate the benefits offered by the third-party website 106 to the owner, e.g., eliminating the owner's statutory benefit of accelerated Patent Office examination offered by Peer-to-Patent. These actions can change the dynamics of the third-party website 402. For example, by offering greater rewards to the users 106 for completing the prior art search on the host website 102, the host website 102 offers an incentive to uncover more relevant prior art so that a patent application is more likely to be found unpatentable or the claims limited based on a greater number of prior art submissions. In addition, by eliminating Peer-to-Patent's benefit of accelerated examination, the host website 102 can encourage patentees to participate in Peer-to-Patent's finder's searches to avoid the patent application from being selected by the host website after the 18-month statutory publication period.

The host website 102 can provide incentives, as it can be funded more readily than the third-party website 402 because a predetermined number of applications can be selected (ranging from 80 to 100, to a few hundred or thousand yearly) depending on funding. Since, Peer-to-Patent is a public forum in collaboration with the USPTO, it provides the prior art searching process to all applicants; that is, theoretically all of the 400,000 or so U.S. patent applications filed each year could be posted on Peer-to-Patent. Providing cash incentives on that scale would clearly be impracticable. The host website 102 can therefore offer a fixed cost structure for providing incentives regardless of the total number of applications submitted for posting in the third-party website 402.

The particular award that may be owing to a given participant is determined by the incentive calculation module 208. This module preferably follows a rule-based approach to calculate an incentive, based on factors and algorithms selected by the proprietor of the host website 102. These factors could be related to the quality of the finder's search results that are submitted on the third-party website 104, for example. The calculation module 208 could also use techniques that generate a variety of economic incentives for the users 106 based on various factors such as the closest prior art as determined on the third-party website 104. Here, as noted above, the Peer-to-Patent system employs a peer review system to determine the top 10 submitted prior art references, and the calculation module 208 can piggy-back on that determination. Other techniques could use factors such as citation data to identify the best art in a given technology area. Incentive could be based on the quality of submissions, as set out above, or on simply the greatest number of prior art references, regardless of the relevancy. In another system, incentive could depend on a predetermined level of relevancy or, with an eligibility fee to submit prior art to encourage the submission of only relevant prior art submissions), the greatest number of relevant prior art references, or the greatest number of participation activities (such as providing prior art or reviewing submitted prior art). The incentive calculation module 208 can use any of the above-mentioned factors, either together or separately, while calculating the incentives. It will be understood that any mathematical models can be applied to calculate the incentives, and that the incentive calculating techniques are out of the scope of the present invention.

The incentive could be a lottery system where predefined activities trigger eligibility for the lottery. For example, every time a predefined participation activity occurs (e.g., a prior art submission is determined to be one of the top 10 prior arts for a patent application), the source user 106 is awarded a “ticket” for eligibility for the lottery on a predetermined basis (e.g., quarterly or yearly). One consideration for an incentive applied on multiple postings is to reduce the analysis needed to identify winners. Using Peer-to-Patent “top 10” rankings simplifies the calculations considerably.

In certain cases, the incentive calculation module 208 may display a list of incentive types from which the participant can chose. For example, the incentive calculation module 208 can display monetary incentive, profit sharing points, offers, discounts, participation in a lottery, and so on. The participants can select the incentive they would like to avail from the displayed list, in case they provide search results that qualify for an incentive.

In one embodiment, similar incentives (such as monetary remuneration, profit sharing points, and participation in a lottery) can be applied to owners in the first tier 204, e.g., providing incentives to patentees or assignees who submit the greatest number of patent applications on the third-party website 104.

Alternatively, the incentives can also be provided to participants who submit finder's search subject matter (i.e., second tier 406). However, the incentives offered for submissions in the first tier and the second tier can vary. For example, submitting subject matter in the first tier 404 attracts a higher incentive than submitting subject matter in the second tier 406.

Further, the incentives provided for finder's search results can vary depending on the source of the subject for the finder's searches. For example, if the patent application selected for incentivizing for selected from the first tier 404, the incentives offered can be higher than if the patent application were selected from the second tier 406.

In addition to calculating the incentives, the incentive calculation module 208 provides information about the calculations made. This information can be communicated in a public manner, such as by posting on the host website 102, or privately, as in a email message to the concerned participant. The manner and mode of providing information can be left to the discretion of the host website 102 proprietor.

In yet another embodiment, participants may designate another party to receive their incentive. For example, a participant could decide to transfer her incentive to the third-party website 402, or to any other participant, or to return the incentive back to the host website 102, or to designate any other third-party to receive the incentive.

In one embodiment, the first tier and the second tier can be present on the same website. For example, the third-party website 402 can include the first tier 404 with voluntary submission and the second tier 406 with involuntary submission. Different incentives can be applied for the two tiers, and benefits offered in the first tier can be removed from the second tier. In an alternate embodiment, the first and second tiers can be present on separate websites. For example, the first tier on the third-party website 402 and the second tier on the host website 102. As a further mechanism to enrich participation in the third-party website 104, the incentives offered by the host website 102 can be based in whole or part on participation on the third-party website 104. The host website 102 incentives can be determined based on participation in the third-party website, e.g., the number of top 10 relevant prior art submissions or the total number of prior art submissions regardless of determined relevance etc. The flat monetary incentives can be variable, based on the number of participation activities by a single member of the public on the third-party website 102. For example, a given incentive, may be available in varying levels depending upon the number of participation activities on the third-party website 104. In this set of embodiments, numerous components are directed to enriching the participation in the third-party website 402 by encouraging owners to submit patent applications to the first tier 404 instead of potentially being involuntarily selected by the host website 102, and by providing incentives, which relate to participation on the third-party website 104.

Funding for the host website 102 can be implemented by the third-party website, or by an independent source, or by the host without any contribution from participants, or in part, by charging the participants an eligibility fee. For example, the host website 102 could charge a prior art submission fee, such as $10 per prior art submission. Where an exemplary incentive is $1,000, 100 submissions would cover the cost, or if the submission amount were $25, 40 submissions would cover the cost. The submission cost would also serve to potentially reduce the submission of irrelevant prior art, thereby reducing the workload for the third-party website 104 to process the top 10 or closest prior art submissions.

In another embodiment, the third-party website 104 and host website 102 can overlap in timing and subject matter, such as, e.g., for the published patent applications or patents. However, one website is voluntary and the other is involuntary and either the voluntary or involuntary website provides a benefit to a participant (e.g., the owner or submitter of prior art or both). The existence of the involuntary website can either positively or negatively motivate users 106 to participate in the voluntary website.

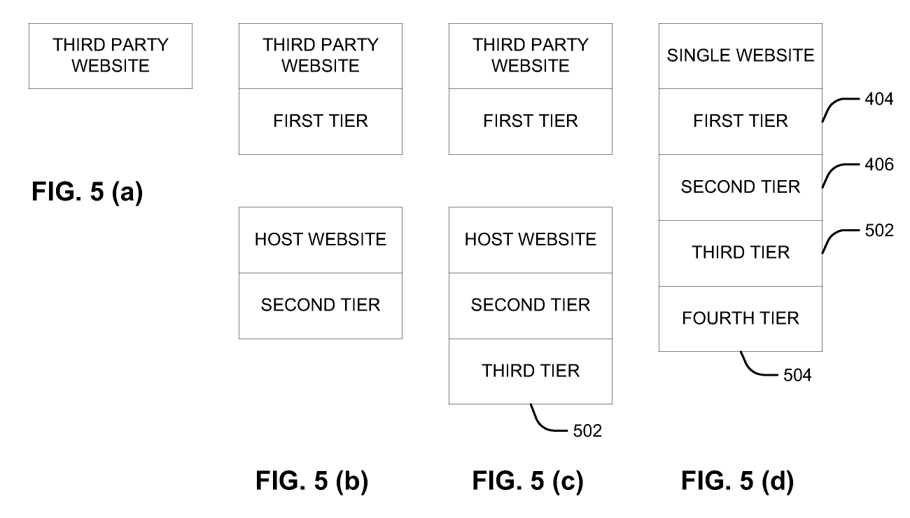

FIGS. 5(a)-5(d) illustrate alternative implementations of tiers according to the claimed invention. FIG. 5(a) illustrates a third-party website, such as the third-party website 104. The third-party website can offer actions to be completed by user participation. In one implementation, the third-party website can offer finder's searches, such as prior art searches for patent applications, and invalidity searches for issued patents, and so on.

FIG. 5(b) illustrates the third-party website 402 with the first tier 404 and the host website 102 with the second tier 406 as described with reference to FIG. 4. FIG. 5(c) is an alternate embodiment where, the third-party website 402 with the first tier 404 remains the same, while a third tier 502 is added to the host website 102. The third tier 502 includes finder's search subject matter such as patent applications, or issued patents submitted voluntarily by the owners. A benefit of volunteering is that the owner can receive and analyze the prior art results and have ownership of it. The owner can provide the determination of whether the submitted prior art invalidates the subject patent or application posting. Should the owner not volunteer, the patent can be involuntarily posted on the host website 102 in the second tier 406 where the owner can have no control over the posting, the analysis, nor ownership of the resulting submissions. The results of the prior art search can be beneficial to the owner, which acts as a further encouragement to voluntarily submit patent applications to the first tier 404.

When an owner submits an issued patent to the third tier 502, the owner can receive added benefits (such as for example, the host website 102 can provide results of the finder's search directly to the owner for a payment). Further, the host website 102 can provide a private outcome to the owner without a public announcement, and actual participant who submits relevant search results can be given an incentive and the outcome of the finder's search can be stated as ‘private’ on the host website 102. In certain situations, the host does not provide a direct benefit to the owner.

FIG. 5(d) illustrates an alternate tier embodiment. Here, all the tiers are present on a single website, which can the host website 102, or the third-party website 104, or any other website. Further, a fourth tier is added to the website. The fourth tier 504 includes a listing of patent applications or issued patents automatically added by the host website 102 (with or without the assistance of third parties).

In another embodiment, the fourth tier can be added to the host website 102 along with the second and third tiers. The host website 102 systematically selects and posts patents and/or provides an announcement of the outcome of the prior art search, and one or more of the identity of the winner, the winning submissions, a validity opinion and/or the collection of submissions. In this way, the impact of involuntary submission can act as an incentive for owners to voluntarily submit patents in the third tier 502 where they can maintain greater control over the process and outcome. In another embodiment, voluntary posting of a patent by the owner in the third tier 502 can insulate the patent from involuntary consideration by the host website 102 in the fourth tier 504.

Based on the present Peer-to-Patent.com structure, adding the host website 102 to enrich public participation in the third-party website 104, and providing incentives to participate in the third-party website 104 and the host website 102 can contribute to patent law reform. The host website 102 can be a private sector process, which bolsters Peer-to-Patent as a public sector reformer. The host website 102 addition and incentives can provide cost effective structures according to the various embodiments of the invention, to optimize the use of finder's searches to the benefit of patent law reform.

The use of voluntary and involuntary submissions on a single or multiple websites can provide dynamics for optimizing the number of patentees who voluntarily submit their patents, and the quantity and quality of prior art submissions provided at the lowest overall cost.

It is foreseeable that just as the process implemented in Peer-to-Patent.com resulted in a supportive change in patent law to support its process, the embodiments of this invention can be used as a basis for the Patent Office or Congress to provide further incentives to patentees.

Hosting the host website 102 and the third-party website 104 on the same or different sources does not limit the scope of this invention. Where a single source is used for the third-party website 104 and host website 102, the postings can appear together with or without information about whether the posting is in the first or host website or about the publication date of the application. The various single- or multiple-source implementations of the third-party website 104 and the host website 102 do not limit this invention.

The criterion or set of criteria to select patent applications does not limit this invention. One or more multiple and distinct selection criteria can exist for various areas of technology, depending upon the participation of the users 106. Patent applications can be selected at random from a subset or totality of published applications. The selection of one or more patent applications for the host website process does not limit the scope of this invention.

The description above of public forums does not limit this invention. The public forums can be any means of public communication, such as, e.g., historically newspapers, e-mail, any network or any means of communication between two individuals. The description of members of the public does not limit this invention. The platform can be open to all members of the public through the internet or any form of communication (e.g., it can be advertised in print or networked through networking web sites, sent via e-mail or the postal system). Alternately, the platform can be targeted and limited to any subset of members of the public, e.g., through networks for individual institutions, schools, academic or public groups, members can be charged to participate, or access can be free, there can be an application process etc.

The prior art search presented on the third-party website 104 provides an accelerated prosecution incentive to patent applicants. There are other advantages and risks to participating (these subjects are covered exhaustively in scholarly writing on the subject; see the Peer-to-Patent.com website).

The host website's prior art search can be triggered for implementation at a predetermined time based on patent law statutes and can provide additional benefits to certain participants and/or the elimination of benefits to certain participants. The host website 102 execution, timing, and altered motivations may change the motivations of the participants in the third-party website 104 to maximize the use and effectiveness of the third-party website.

The host website 102 and third-party website 104 are described above as structured in a number of modules. As will be understood by those in the art, such modules are defined functionally, and those in the art are able to convert such functional requirements into coded modules, using any of a number of hard-coded computer languages, such as native HTML, C++ and the like, or employing web design tools such as Visual Studio. Further, the stated functions can be divided into modules in a manner differing from that set out above, yet performing the functions described. These and other modifications can be made by those in the art without departing from the scope of the invention, which is defined solely by the appended claims.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In sum, by creating incentives on both sides—for submitting prior art and for posting patents—the system of review is enhanced, and multiple platforms are provided for submitting prior art and posting patent applications and issued patents. A larger market sector is created with multiple participants, allowing a host site and similar sites to benefit from the synergy of multiple participants, to build off of their user communities and even to provide grants to those other sites. This result benefits inventors, technology owners, and the public at large.

What is claimed is:

1. A system for incentivizing an action offered by a third-party website, the system comprising:
a host website, including:
an offering module configured to display an incentive for taking an action on the third-party website;
a user interface module configured to:
register users as participants; and
accept inputs from participants;
a reporting module, configured to
receive a report of an action on the third-party website; and
receive the identity of the participant taking the action;
an incentive calculation module configured to:
calculate an incentive applicable to the identified action; and
provide information regarding the calculated incentive; and
a data storage module configured to assemble, store, retrieve and process information regarding the participant and the third-party website action.

2. The system of claim 1, wherein the host website offers an incentive to take the action and the third-party website does not offer an incentive.

3. The system of claim 1 wherein both the host website and the third-party website offer incentives, and the incentives of the host website are larger than similar incentives offered on the third-party website.

4. The system of claim 1 wherein both the host website and the third-party website offer incentives, and the incentives of the host website are the same as the similar incentives offered on the third-party website, wherein the total incentives for the participants is doubled.

5. The system of claim 1 wherein both the host website and the third-party website offer incentives and the incentives of the host website are larger than similar incentives offered on the third-party website, wherein the total incentives for the participants is doubled.

6. The system of claim 1 wherein one participant is the third-party website.

7. The system of claim 1, the host website further including a monitoring module, configured to
monitor actions reported on the third-party website; and
identify actions taken by participants.

8. The system of claim 1, wherein the actions include one or more of submitting prior art for published patent applications, or issued patents, submitting prior art that is peer reviewed for relevance for published patent applications, or issued patents, submitting prior art that is selected as relevant for published patent applications, or issued patents, submitting prior art that is selected as one of the top predetermined number of references for published patent applications, or issued patents, or reviewing published patent applications, or issued patents.

9. The system of claim 1, wherein the incentives include one or more of monetary remuneration, profit sharing points, or participation in a lottery.

10. The system of claim 1, wherein the host website is not affiliated with the third-party website.

11. A system for incentivizing finder's searches related to pending patent applications, issued patents, or other patent-related documents offered by a third-party website for the purpose of soliciting finder's search results from users, the system comprising:
a host website, including:
an offering module configured to display an incentive for providing finder's search results on the third-party website;
a user interface module configured to:
register users as participants; and
accept inputs from participants;
a reporting module, configured to
receive a report of finder's search result provided to the third-party website; and
receive the identity of the participant providing finder's search result to the third-party website;
an incentive calculation module configured to:
calculate an incentive applicable to the identified finder's search result; and
provide information regarding the calculated incentive; and
a data storage module configured to assemble, store, retrieve and process information regarding participants, third-party website finder's searches, and finder's search results.

12. The system of claim 11, the host website further including a monitoring module, configured to
monitor finder's searches reported on the third-party website; and
identify finder's searches provided by participants.

13. The system of claim 11, wherein the incentive calculation is related to the quality of the finder's search results, as presented on the third-party website or made available to the public and inputted into the reporting module.

14. A system for incentivizing the listing of patent documents on a third-party website displaying pending patent applications, issued patents, or other patent-related documents for the purpose of soliciting finder's search results from users, the system comprising:
a host website, including:
an offering module configured to display an incentive for providing finder's search results on the third-party website;
a user interface module configured to:
register users as participants; and
accept inputs from participants;
a reporting module, configured to
receive a report of finder's search result provided to the third-party website; and
receive the identity of the participant providing the finder's search result to the third-party website;
an incentive calculation module configured to:
calculate an incentive applicable to the finder's search results; and
provide information regarding the calculated incentive; and
a data storage module configured to assemble, store, retrieve and process information regarding participants, third-party website actions, and finder's search results;
wherein the third-party website includes a first tier, listing pending patent applications and issued patents voluntarily submitted by the owners thereof, and the host website, the third-party or another third-party web site includes a second tier, listing patent applications and issued patents submitted by parties other than the owners thereof and wherein the owners are offered a patent posting incentive to volunteer their pending patent applications or issued patents on the third-party website first tier.

15. The system of claim 14, wherein the patent posting incentive includes one or more of monetary remuneration; profit sharing points; or participation in a lottery; accelerated patent examination at the U.S. Patent Office for pending applications; removal from consideration for listing on the second tier of the host website or the other third-party website; patent quality rating based on a finder's search for prior art or an indication of patent quality of examination or prior art searches applied to the determination of patentability.

16. The system of claim 14, wherein the incentive calculation is affected by whether the subject of the finder's search is included in the first tier of the third-party website or the second tier of the host website or the other third-party website.

17. The system of claim 16, wherein the incentives are higher if the subject of the finder's search is included in the first tier of the third-party website than if the subject of the finder's search is included in the second tier of the host website, the third-party website or the other third-party website.

18. The system of claim 14, wherein the first tier and the second tier constitute separate websites.

19. The system of claim 14, wherein the patent posting incentive is determined based on whether the owner or applicant of the patent document voluntarily submits the patent document for a prior art search.

20. The system of claim 14, wherein the participants select the incentive to be awarded, from a list of incentives.

21. The system of claim 14, wherein the participant can designate a party to receive any incentive due that participant.

22. The system of claim 21, wherein the designated party is the third-party website.

23. A system for incentivizing the listing of patent documents and finder's search results to a third-party website displaying pending patent applications, issued patents, or other patent-related documents for the purpose of soliciting finder's search results from users, the system comprising:
a host website, including:
an offering module configured to display an incentive for providing finder's search results on the third-party website;
a user interface module configured to:
register users as participants; and
accept inputs from participants;
a reporting module, configured to
receive a report of finder's search result provided to the third-party website; and
receive the identity of the participant providing the finder's search result to the third-party website;
an incentive calculation module configured to:
calculate an incentive applicable to the finder's search results; and
provide information regarding the calculated incentive; and
a data storage module configured to assemble, store, retrieve and process information regarding participants, third-party website actions, and finder's search results;
wherein the third-party website includes a first tier, listing pending patent applications and issued patents voluntarily submitted by the owners thereof, and the host website, the third-party or another third-party web site includes a second tier, listing patent applications and issued patents submitted by parties other than the owners thereof and wherein the owners are offered a patent posting incentive to volunteer their pending patent applications or issued patents on the third-party website first tier, and participants are offered the incentive for submitting finder's search results.

24. The system of claim 23, wherein the patent posting incentive includes one or more of monetary remuneration; profit sharing points; participation in a lottery; accelerated patent examination at the U.S. Patent Office for pending applications; removal from consideration for listing on the second tier of the host website or the other third-party website; or patent quality rating based on a finder's search for prior art or an indication of patent quality of examination or prior art searches applied to the determination of patentability.

25. The system of claim 23, wherein the finder's fee incentive includes one or more of monetary remuneration; profit sharing points; or participation in a lottery.

26. The system of claim 23, wherein the incentive calculation is affected by whether the subject of the finder's search is included in the first tier of the third-party website or the second tier of the host website or the other third-party website.

27. The system of claim 26, wherein the incentives are higher if the subject of the finder's search is included in the first tier of the third-party website than if the subject of the finder's search is included in the second tier of the host website, the third-party website or the other third-party website.

28. The system of claim 23, wherein the first tier and the second tier are implemented on separate websites.

29. The system of claim 23, wherein the host website includes a third tier, listing pending patent applications and issued patents voluntarily submitted by the owners thereof, and the host website, further includes a fourth tier, listing patent applications and issued patents automatically added by the host website and wherein the owners are offered a patent posting incentive to volunteer their pending patent applications or issued patents on the third-party website first tier, and participants are offered finder's fee incentives for submitting finder's search results.

30. The system of claim 29, wherein the first, second, third, and fourth tiers are contained in the host website.

31. The system of claim 23, wherein the patent posting incentive is determined based on whether the owner or applicant of the patent document voluntarily submits the patent document for a prior art search.

32. The system of claim 23, wherein the participant selects the incentive to be awarded, from a list of incentives.

33. The system of claim 23, wherein the participant can designate a party to receive any incentive due that participant.

34. The system of claim 31, wherein the designated party is the third-party website.
